(19) United States
(12) Patent Application Publication
(10) Pub. No.: US 2026/0281609 A1
(43) Pub. Date: Sep. 17, 2026

(54) LOUDSPEAKER ASSEMBLY COMPRISING MULTIPLE-DRIVERS

(71) Applicant: EXIGY LIMITED, Chesham (GB)

(72) Inventor: Matthew James DOBSON, Chesham (GB)

(21) Appl. No.: 19/672,473

(22) Filed: May 8, 2026

Related U.S. Application Data
(63) Continuation of application No. PCT/GB2024/052855, filed on Nov. 8, 2023.

(30) Foreign Application Priority Data
Nov. 10, 2023 (GB) 2317245.5

(51) Int. Cl. H04R 1/24

(52) U.S. Cl. CPC H04R 1/24

(57) ABSTRACT

A multiple-driver loudspeaker, for converting electrical signals into acoustic sound, comprising a plurality of driver assemblies, each driver assembly including a pair of drivers arranged on a common central driver axis bisected by a driver midpoint lying between the drivers, the plurality of driver assemblies including: a first group of driver assemblies in which the midpoint of each driver assembly lies on a perimeter of a first circular plane; and a second group of driver assemblies in which the midpoint of each driver assembly lies on a perimeter of a second circular plane; wherein the first and second circular planes each extends around a common central planer axis.

### FIELD OF INVENTION

This invention relates to a multiple-driver loudspeaker for converting electrical signals into acoustic sound.

### BACKGROUND TO THE INVENTION

While it is possible to make a single loudspeaker chassis (the transducer part of a loudspeaker system, hereafter referred to as a ‘loudspeaker driver’ or ‘driver’) capable of making sound across the entire frequency range of human hearing (20 Hz to 20 kHz is the generally accepted range), any driver small enough to produce the upper limit well, will have such a small output at the lower end that it will be below our hearing sensitivity threshold. Conversely, a driver large enough to produce acceptable Sound Pressure Level (the sound pressure at a single point in space, hereafter referred to as ‘SPL’) at low frequency (LF), will fail to produce high frequency (HF) other than in a very narrow beam and with low efficiency. The explanation for these limitations is found in comparing the relative size of the radiating surface with the wavelength being produced. At 20 Hz the wave length of sound is approximately 17 metres, at 20,000 Hz the wavelength is approximately 17 millimetres. For best efficiency the radiating surface diameter should approach or exceed the wavelength, for wide dispersion (creating equal SPL over a large area) the radiating surface diameter should be significantly smaller than the wavelength. A large surface will be heavy and difficult to accelerate to HF; a small surface can't move much air at low frequency. These conflicting requirements explain why many existing loudspeakers are compromised to a greater or lesser extent in terms of efficiency and/or dispersion.

For some uses, a single small driver may provide a good compromise. Such a loudspeaker will have low efficiency, be limited in LF output, the HF will be directional, and the maximum SPL will be low. However, these limitations may not always be a problem, while an advantage of this approach is coherency as all output emanates from one relatively small surface. Many devices in use today are in this category and make use of such loudspeakers, including small radios, TV's, speaker phones etc.

However, for many applications, higher SPL's and/or a wider frequency response is required than is possible with a single-driver loudspeaker.

If the frequency range of a driver is restricted to cover only part of a loudspeaker target frequency response, better optimisation of the driver is possible. A loudspeaker can make use of more than one driver, each driver being optimised to cover a target frequency response, such that in combination the multiple drivers are able to cover the entire target frequency response of the loudspeaker. A loudspeaker containing more than one driver, with different drivers being optimised for different frequency ranges may be referred to as a “multi-way loudspeaker”.

In this disclosure, the terms “multi-way” and “multiple driver” may in some examples be used interchangeably. In some examples, a multiple driver loudspeaker may refer to a loudspeaker that has more than one driver covering a single frequency band. Additionally, or alternatively, a multiple driver loudspeaker may include more than one driver with different drivers being optimised for different frequency ranges (i.e., a multi-way loudspeaker).

If more than one design of driver is used in a single loudspeaker and each is optimised to reproduce different parts of the target system frequency response, a means to split the full range signal into the appropriate bands is required. This device is usually called a ‘crossover’ and most often comprises passive electrical or active electronic components (there also exist mechanical and acoustical crossovers while drivers themselves exhibit some band limiting) to filter the source signal into frequency ranges. More recently, these tasks have been done in the digital domain with the results converted back to analogue and amplified, then fed to each frequency band. Typically, each frequency band is called a ‘way’, so a two-frequency band loudspeaker is referred to as a ‘2-way’ design etc. It is generally agreed that crossing between different drivers can cause problems and is best avoided. It is also generally agreed that virtually all wide frequency response loudspeaker systems capable of high SPL require at least one crossover and may require several, the consequences have to be accepted. A good loudspeaker system design is one that balances the compromises imposed by the design goals.

If different driver designs are used within the same loudspeaker system each producing a different frequency band, they will occupy different physical positions. At the crossover centre frequency, each frequency band is contributing equally to the output and to a reducing degree, either side of the centre frequency, (the overlap region) then the acoustic output is the sum of the acoustic outputs from distance separated discrete sources. If, as is almost always the case, the physical location of the drivers is separated by more than the sum of the two driver's radii, and this distance is of the order of half the wavelength anywhere in the overlap region, there will be certain points in space where the two outputs are non-coherent and full or partial acoustic cancellation occurs. If the output is visualised as a uniform sphere of sound all around a loudspeaker with a consistent spherical shape at all frequencies, these cancellations would look like dips in the surface, small and deep, wide and shallow and sometimes both wide and deep, the degree and position changing with change in frequency. The quantity, position, size and degree of cancellation dips are a function of driver size, driver spacing and the acoustic frequency response of each driver/crossover combination. There are many hundreds, even thousands of different possible designs of loudspeakers that attempt to address these problems. It is thought that a large part of the “acoustic signature” of any given loudspeaker is the result of a non-ideal radiation pattern.

Above, it is noted that that broadest dispersion is achieved with a radiating surface with a diameter significantly smaller than the wavelength being produced. As an example, FIG. 1a is the calculated radiation pattern of a single 200 mm disk mounted in an infinite flat baffle with infinite air volumes front and back, working between 100 Hz and 10 kHz. The many cancellations shown in the figure are caused by radiation from different parts of the disk becoming out of phase as the wavelengths become shorter. The first cancellations are seen at angles far from ‘on axis’ or 0 degrees, as it is here that the path length difference is greatest between opposite sides of the disk. As wavelengths decrease with higher frequencies, cancellation occurs at ever smaller angles.

The graph in FIG. 1 a shows the calculated output from the disk at 0, 10, 15, 20, 30, 45, 60 and 90 degrees from “on axis”. As illustrated in the figure, the output starts to reduce at wide angles from as low as 400 Hz (wavelength=860 mm or approximately 4 times the radiator diameter). In practice, a 200 mm radiator is often used to much higher frequencies, 2 kHz to 2.5 kHz may be the crossover point in a simple two-way design.

As discussed in a previous patent granted to the inventors (GB2522055), the content of which is hereby incorporated by reference, arranging multiple drivers co-axially can result in improved performance. In particular, a coaxial arrangement of drivers allows for crossover design to approach ideal, i.e. near perfect summation and phase over a wide dispersion angle. Co-axial drivers have existed since the mid-20^{th} century, usually 2-way, with a high frequency driver located in the centre of a low frequency driver. Three and even 4-way versions have been made, the limitations and problems of such co-axial designs are well known. The 2014 patent GB2522055 presented a way to synthesise multi-way co-axial loudspeakers using groups of drivers for each frequency band. FIG. 1b shows the output from 4 smaller identical disks of total radiating surface area equal to the disk of FIG. 1a, spaced equally around a central point. It shows that output is almost identical up to 400 Hz. By using the spaces between these 4 disks to locate another 4 smaller disks, which form the next band above 400 Hz, the net or virtual acoustic centre of each band may be made to co-locate either exactly or very closely in x, y and z directions. With a good choice of driver sizes, positions and crossover characteristics, near perfect summation is possible, at all angles. It is possible to scale this result to cover multiple frequency bands. By limiting the frequency range any band has to cover, cancellations between drivers within a band can be reduced or eliminated. If near perfect summation is available, multi-way loudspeakers are possible without disadvantage. Small or large multi-way loudspeakers may be made with the advantage of almost perfectly even dispersion at all angles to nearly 180 degrees, throughout almost the entire human hearing range.

However, issues remain with multiple driver coaxially arranged loudspeaker designs. With bands of multiple front-facing drivers, it is almost impossible to use anything but a flat front baffle for the overall loudspeaker cabinet, thereby limiting potential benefits that could be achieved by including surface shaping. Furthermore, including multiple front-facing drivers in close proximity can cause issues with interference between adjacent drivers. In particular, in designs that include a single central HF driver mounted at the centre of a single lower frequency driver, or surrounded by lower frequency drivers, the adjacent driver(s) can create a discontinuity to the surface as seen by the central HF driver, and these discontinuities can cause ripples in the HF driver response. These discontinuity effects are worsened by the movement of the lower frequency driver surfaces, which change the environment that the central HF driver is working in. Further issues can arise due to diffraction caused from the edges of the lower frequency radiating surfaces of the adjacent drivers which can be exposed at high excursion.

There exists, therefore, a need to provide an improved multiple-driver loudspeaker design capable of overcoming the issues outlined above.

### SUMMARY OF THE INVENTION

According to a first aspect of the invention, there is provided a multiple-driver loudspeaker, for converting electrical signals into acoustic sound, comprising a plurality of driver assemblies, each driver assembly including a pair of drivers arranged on a common central driver axis bisected by a driver midpoint lying between the drivers, the plurality of driver assemblies including:
a first group of driver assemblies in which the midpoint of each driver assembly lies on a perimeter of a first circular plane; and
a second group of driver assemblies in which the midpoint of each driver assembly lies on a perimeter of a second circular plane;
wherein the first and second circular planes each extends around a common central planer axis.

This arrangement of drivers in pairs to form driver assemblies, with the driver assemblies being arranged on a circular plane, is advantageous as the total radiating surface can be larger than would be possible with front facing driver groups contained within the same overall diameter. Since each group of driver assemblies comprises at least four drivers, this means that the total radiating surface can be larger than for comparative existing designs that use single (i.e., not paired) surface-facing drivers within the same overall diameter. This is also advantageous in that the overall diameter of each circular plane can be reduced while still maintaining a large radiating area. By arranging the drivers in assemblies, and the assemblies in groups, the total radiating area of a group of assemblies may be larger than would be possible using a forward-facing driver of the same overall diameter as the circular plane on which the driver assemblies are arranged. This arrangement of driver groups can allow for improved dispersion of the acoustic sound, and also allow for larger drivers to be used.

A further advantage of this arrangement of drivers is that the radiating surface, as seen by a central higher frequency driver, or other multi-driver higher frequency band, is much less compromised by the output from lower frequency bands, because they exit via apertures that may be of much smaller area than the summed surface area of the actual drivers that create the output. Hence, the radiating surface, as seen by each higher frequency band, may appear to be physically similar to a surface without lower frequency bands. Furthermore, high excursion of the drivers in lower frequency bands causes no physical change to the radiating surface seen by the higher frequency band driver(s).

With this arrangement of drivers and driver assemblies, the length of each voice coil in each group of driver assemblies can be added to give a total length equivalent. For example, a group comprising eight 25 mm diameter coils have a total length of 8×25×π=628 mm, which is the same length as a single 200 mm diameter coil, a totally impossible coil size for a single driver of equivalent diameter. The coil surface area equates to the heat dissipation (assuming other conditions are equal), so for a given power input, temperature is reduced, and power compression (which causes acoustic compression) is lowered. Compression in a driver is caused by elevated coil temperatures and the subsequent rise in coil resistance. Thus, drivers used in the multiple-driver loudspeakers, according to the present invention, will be more resistant to both thermal compression and thermal failure since operating temperatures will be lower for the same acoustic output.

Using multiple drivers within a given frequency band and with each driver contained within an individual enclosure, may be advantageous. If, for example, all internal dimensions of the enclosure are much smaller than the shortest wavelength it's required to produce, there will be no internal reflections and no standing waves.

Preferably, there is provided a multiple-driver loudspeaker wherein each driver assembly comprises a pair of matched drivers. Matching the drivers such that they are essentially identical is advantageous as it allows for each driver assembly to convert electrical signals into acoustic sound with minimal distortions and high efficiency.

Preferably, there is provided a multiple-driver loudspeaker wherein each driver assembly is arranged such that, in use, the pair of drivers of the driver assembly force-cancel. This is advantageous as it minimises the inertial forces exerted by the drivers when converting electrical signals into acoustic sound. Such an arrangement allows for the drivers to exert force only on the air, instead of both air and the supporting structure, thereby to produce the acoustic sound. This is advantageous as it may improve the efficiency of the loudspeaker drivers, while also reducing the energy imparted into the cabinet structure. This may, in turn, allow for a reduction in the structural rigidity, strength and damping, needed in the overall loudspeaker cabinet.

Preferably, for each force cancelling driver assembly the paired drivers are either:
arranged facing each other and are driven using an electrical signal of the same polarity; or
arranged facing in the same direction and are driven with an electrical signal of opposite polarity to one another. Either arrangement is advantageous as it allows for the inertial forces produced by each of the pair of drivers to be cancelled out, thereby reducing or preventing the drivers from exerting any inertial force on any surrounding structural components of a loudspeaker. Drivers facing the same direction (with opposed polarity drive) may advantageously cancel certain driver borne distortions.

Preferably, there is provided a multiple-driver loudspeaker wherein the first and second circular planes are co-planar. This is advantageous as it allows for driver assemblies from separate groups to be arranged more closely. This is also advantageous as it allows for the driver assemblies to be arranged such that the virtual acoustic centre of all of the driver assemblies in each respective group is as close as possible to a single central point, thereby allowing for the best summation of acoustic sound output in all directions around the loudspeaker.

Preferably, there is provided a multiple-driver loudspeaker wherein the first and second circular planes have different diameters. This is advantageous as it may allow for the driver assemblies of each respective group to be arranged more closely together, for example by interleaving driver assemblies from different circular planes. This may improve the use of available space within the loudspeaker. This may also be advantageous in allowing for the driver assemblies to be arranged in order to optimise the summation of acoustic sound output in all directions around the loudspeaker due to the effective diameter of each radiating group being small relative to its radiating area.

Preferably, there is provided a multiple-driver loudspeaker wherein the diameter of the first circular plane is smaller than the diameter of the second circular plane. This is advantageous as it may allow for the driver assemblies of each respective group to be arranged more closely together, for example by interleaving driver assemblies from different circular planes.

Preferably, there is provided a multiple-driver loudspeaker wherein for each respective circular plane, those driver assemblies lying on a perimeter of the circular plane are equally spaced from one another around the circular plane. This is advantageous as it improves the uniformity of the acoustic sound produced by the driver assemblies. Such an arrangement is also the most efficient way to interleave the drivers so allowing the smallest diameter groups. However, if the cabinet design has an un-equal aspect ratio such as one with a rectangular front face, it may in certain circumstances, be physically advantageous to space the driver groups on the cabinet diagonals, so they will be at equal distance from the centre, but not exactly evenly spaced from one another.

Preferably, there is provided a multiple-driver loudspeaker wherein the drivers of the first group of driver assemblies are smaller than the drivers of the second group of driver assemblies. This is advantageous as it may improve the spatial efficiency with which the driver assemblies may be arranged within the loudspeaker.

Preferably, there is provided a multiple-driver loudspeaker wherein, in use, the first group of driver assemblies are configured to produce frequencies in a first, and the second group of driver assemblies are configured to produce frequencies in a second frequency band that is at least partially non-overlapping with the first frequency band. This is advantageous as it allows for different groups of driver assemblies to be optimised to produce acoustic sound in different frequency ranges. By limiting the required range of acoustic sound frequencies that a driver assembly is required to produce, each driver or driver assembly can be optimised to produce that range of frequencies more efficiently. This is also advantageous as drivers that are optimised for producing a narrow range of frequencies are typically less expensive, smaller, and less complex than drivers that are able to produce a wider range of frequencies. Furthermore, drivers are typically more energy efficient when operating in their optimal frequency range.

According to a second aspect of the invention, there is provided a multiple-driver loudspeaker, for converting electrical signals into acoustic sound, comprising three or more driver assemblies, each driver assembly including a pair of drivers arranged on a common central driver axis bisected by a driver midpoint lying between the drivers, the midpoint of each of the three or more driver assemblies lying on a perimeter of a single circular plane.

This arrangement of drivers in pairs to form driver assemblies, with the driver assemblies being arranged on a circular plane, is advantageous as the total radiating surface can be larger than would be possible with front facing driver groups contained within the same overall group diameter. Since each group of driver assemblies comprises at least four drivers, this means that the total radiating surface is larger than for comparative existing designs that use single surface-facing drivers (or even groups of surface-facing drivers). This is also advantageous in that the overall diameter of each circular plane can be reduced while still maintaining a large radiating area. By arranging the drivers in assemblies as described above, and arranging the assemblies around a circular plane, the total radiating area of a group of assemblies may be considerably larger than would be possible using a forward-facing driver (or group of forward-facing drivers) of the same overall diameter as the circular plane on which the driver assemblies are arranged. Furthermore, this arrangement of driver groups can allow for improved dispersion of the acoustic sound by virtue of its smaller diameter, and also allow for larger drivers to be used. As discussed in relation to the first aspect, this arrangement also offers advantages in relation to thermal performance and energy efficiency.

Preferably, there is provided a multiple-driver loudspeaker wherein each driver assembly comprises a pair of matched drivers. Matching the drivers such that they are essentially identical is advantageous as it allows for each driver assembly to convert electrical signals into acoustic sound with minimal distortions and high efficiency.

Preferably, there is provided a multiple-driver loudspeaker wherein each driver assembly is arranged such that, in use, the pair of drivers of the driver assembly force-cancel. This is advantageous as it minimises the inertial forces exerted by the drivers when converting electrical signals into acoustic sound. Such an arrangement allows for the drivers to exert force only on the air, instead of both air and the supporting structure, thereby to produce the acoustic sound. This is advantageous as it may improve the efficiency of the loudspeaker drivers, while also reducing the energy imparted into the cabinet structure. This may, in turn, allow for a reduction in the structural rigidity, strength and damping, needed in the overall loudspeaker cabinet.

Preferably, for each force cancelling driver assembly the paired drivers are either:
arranged facing each other and are driven using an electrical signal of the same polarity; or
arranged facing in the same direction and are driven with an electrical signal of opposite polarity to one another. Either arrangement is advantageous as it allows for the inertial forces produced by each of the pair of drivers to be cancelled out, thereby reducing or preventing the drivers from exerting any inertial force on any surrounding structural components of a loudspeaker. Drivers facing the same direction (with opposed polarity drive) may advantageously cancel certain driver borne distortions.

Preferably, there is provided a multiple-driver loudspeaker further comprising at least one driver arranged with a driver central axis shared with the common central planar axis of at least one circular plane. This is advantageous because positioning a driver in this location would allow for that driver to produce acoustic sound with the same source location as the average locations of the driver assemblies located on the one or more circular planes. This may allow, for example, for one or more high frequency drivers to provide high frequency acoustic sound with minimal interaction with the surrounding driver assemblies.

Preferably, there is provided a multiple-driver loudspeaker wherein for each respective circular plane, those driver assemblies lying on a perimeter of the circular plane include drivers of equal size. This is advantageous as driver size may be optimised for the frequency range they reproduce while maximising force cancelling as each driver in each pair has identical moving mass to its opposite.

Preferably, there is provided a multiple-driver loudspeaker further comprising a first baffle disposed on a first side of the plurality of driver assemblies, the first baffle comprising one or more openings, each of the one or more openings being arranged adjacent to one of the driver assemblies. This is advantageous as the baffle prevents interference between the acoustic sound produced by the separate driver assemblies. The openings are advantageous as they allow for the acoustic sound produced by the driver assemblies to escape from the loudspeaker through the baffle in particular locations, thereby minimising the interference between acoustic sound produced by different driver assemblies. The openings are further advantageous as they can be placed more closely together than would be possible for typical forward-facing drivers, thereby allowing for closer tessellation between the sound output locations (i.e., openings) for the different driver assemblies.

Preferably, there is provided a multiple-driver loudspeaker wherein the first baffle further comprises shaped portions. This is advantageous as the baffle can be shaped to optimise the overall dispersion pattern. A shallow concave baffle can help match the directivity between frequency bands at upper crossover frequencies while also slightly widening the dispersion at the highest frequencies, other shapes may have other benefits. This is particularly advantageous when compared to forward facing drivers (or driver groups) in loudspeaker designs that typically have, or require flat baffles with the driver(s) diaphragm(s) being shaped to optimise that drivers output, without reference to the needs of other drivers sharing the same baffle.

Preferably, there is provided a multiple-driver loudspeaker further comprising a second baffle disposed on a second side of the plurality of driver assemblies, the second side being opposite to the first side such that the plurality of drivers are disposed between the first baffle and the second baffle, the second baffle comprising one or more openings, each of the one or more openings being arranged adjacent to one of the driver assemblies. This is advantageous as it allows for acoustic sound to be emitted from both the front and the back of the loudspeaker, from an identical position on the common central planar axis, with emissions from both front and back being of the same polarity and in phase, through the openings disposed on the first and second baffles respectively. Such an arrangement allows for the multiple-driver loudspeaker to perform as an “omnidirectional” loudspeaker (a loudspeaker radiating in two directions, both in the same polarity, may also be referred to as a “Bipolar Radiator”). This is because all of the driver assemblies (and, when present, central drivers) emit their sound from a virtual common central point and with the same polarity, which sum efficiently in all directions. Thus, the summation of the acoustic sound produced by the loudspeaker results in an effective, close to ideal, “point source”. This method for producing omnidirectional sound is advantageous as it has fewer compromises than previous attempts at providing such capabilities.

Preferably, there is provided a multiple-driver loudspeaker wherein the second baffle further comprises one or more shaped portions. As with the first baffle, this is advantageous as the baffle can be shaped to optimise the overall dispersion pattern. A shallow concave baffle can help match the directivity between frequency bands at upper crossover frequencies while also slightly widening the dispersion at the highest frequencies. This is particularly advantageous when compared to forward facing drivers (or driver groups) in loudspeaker designs that typically have, or require, flat baffles.

Preferably, there is provided a multiple-driver loudspeaker comprising a pair of matched drivers arranged with a driver central axis shared between the pair of drivers and with the common central planar axis of at least one circular plane, and arranged such that each driver of the pair of matched drivers faces outwards. This is advantageous because positioning a pair of drivers in this position allows for each of those drivers to produce acoustic sound with the same source location as the average locations of the driver assemblies located on the one or more circular planes. This may allow, for example, for a pair of high frequency drivers to provide “omnidirectional” high frequency acoustic sound with minimal interaction with the surrounding driver assemblies. This is because any small diameter, high frequency driver located at the centre of a baffle (shaped or flat) will have its acoustic radiation restricted to a half sphere as, for almost all driver sizes and baffle shapes, the lowest frequency wavelength will be small compared to the size of the baffle. The baffle then prevents omnidirectional radiation and results in something close to a half sphere of radiation. A second high frequency driver placed coaxially (and, for example, back to back) with the first will create another half sphere of radiation, equal in shape and phase with the first so each adds to create near fully spherical radiation. This pair will also force cancel resulting, for this particular configuration, in a loudspeaker assembly where all drivers are in force cancelling pairs.

Preferably, there is provided a multiple-driver loudspeaker further comprising one or more low-frequency driver assemblies, each low-frequency driver assembly including a pair of low-frequency drivers arranged on a common central driver axis, and wherein each of the respective low-frequency driver assemblies is arranged such that the common central driver axis of the low-frequency driver assembly is shared with the common central planar axis of at least one circular plane. These are advantageous as they increase the low frequency (LF) capability of the loudspeaker system. Furthermore, the additional LF drivers remain in a coaxial arrangement with all other drivers.

Preferably, there is provided a multiple-driver loudspeaker including at least one circular plane having a central planar axis, further comprising two or more low-frequency drivers, each low frequency driver having a driver central axis extending perpendicular to the central planar axis of the at least one circular plane, and arranged such that the low frequency drivers are equally spaced from one another. These are advantageous as they increase the low frequency (LF) capability of the loudspeaker system. Furthermore, the additional LF drivers remain in a coaxial arrangement with all other drivers.

Because low frequency (LF) acoustic sound has long wavelengths, more than one LF driver may be used. If the contained space they occupy is small compared to the shortest wavelength (highest frequency) they produce and they are all driven with identical signals, they will each produce omnidirectional output that adds coherently. If the drivers are arranged so that the central driver axis of each of the LF drivers is radially equally distributed and each LF driver is the same distance from a central point, any number, in any orientation, will force cancel. The meeting point of these LF drivers will also be the virtual acoustic centre of the group. If the transition frequency to the next driver or group of drivers in the next higher frequency range has a much longer wavelength than the distance between the virtual acoustic centres of the two groups, the offset will have little reduction from complete summation between the two groups. Such an offset may be required in some arrangements, such as placing LF drivers in another plane (for example, on the sides of the cabinet) or, in the same plane but offset along the common central planar axis of the other drivers (for example, on the back of the cabinet) or, in a mid-cabinet position. All such arrangements of the lowest frequency group can be a part of the proposed invention.

### BRIEF DESCRIPTION OF THE DRAWINGS

Examples of the present invention will now be described in detail with reference to the accompanying drawings, in which:

FIG. 1a illustrates a calculated 200 mm flat disk radiation pattern from 100 Hz to 10 kHz and stepped from 0 to 90 degrees. The disk is flush mounted on an infinite flat baffle with equal air masses on each side of the baffle;

FIG. 1b illustrates a calculated radiation pattern from 4 tightly grouped equal sized disks with a total area equal to the disk in 1A and mounted in the same way on a similar baffle, from 100 Hz to 10 kHz and stepped from 0 to 90 degrees;

FIG. 2 illustrates an example of a multiple-driver loudspeaker according to the present disclosure;

FIG. 3 illustrates an example of a loudspeaker driver;

FIG. 4 illustrates a pair of drivers arranged in a driver assembly, the drivers being arranged face-to-face;

FIG. 5 illustrates a pair of drivers arranged in a driver assembly, the drivers being arranged facing in the same direction;

FIG. 6 illustrates a group of driver assemblies arranged on a first circular plane;

FIG. 7 illustrates a group of driver assemblies arranged on a second circular plane;

FIG. 8 illustrates the groups of driver assemblies from FIGS. 6 and 7 arranged with a common central planar axis;

FIGS. 9 to 13 illustrate various examples of driver orientations and combination in multiple-driver loudspeakers according to the present disclosure;

FIG. 14 illustrates an example of a multiple-driver loudspeaker according to the present disclosure, with an alternative orientation of the driver assemblies;

FIG. 15 illustrates another example an example of a multiple-driver loudspeaker according to the present disclosure, with an further alternative orientation of the driver assemblies;

FIG. 16 illustrates the multiple-driver loudspeaker of FIG. 14 with a circular plane overlaid, to show that the drivers are arranged in accordance with the claimed invention;

FIGS. 17 and 18 illustrate an example of a multiple-driver loudspeaker according to the present disclosure configured to produce “forward facing” sound;

FIGS. 19 and 20 illustrate an example of a multiple-driver loudspeaker according to the present disclosure configured to produce “omnidirectional” sound;

FIGS. 21 and 22 illustrate a further example of a multiple-driver loudspeaker according to the present disclosure configured to produce “omnidirectional” sound;

FIGS. 23 and 24 illustrate an example of a multiple-driver loudspeaker according to the present disclosure configured to produce “forward facing” sound including additional low frequency drivers, with the additional low frequency drivers arranged on outer faces of the loudspeaker housing; and

FIGS. 25 and 26 illustrate a further example of a multiple-driver loudspeaker according to the present disclosure configured to produce “forward facing” sound including additional low frequency drivers, with the additional low frequency drivers arranged in a low frequency driver assembly pair.

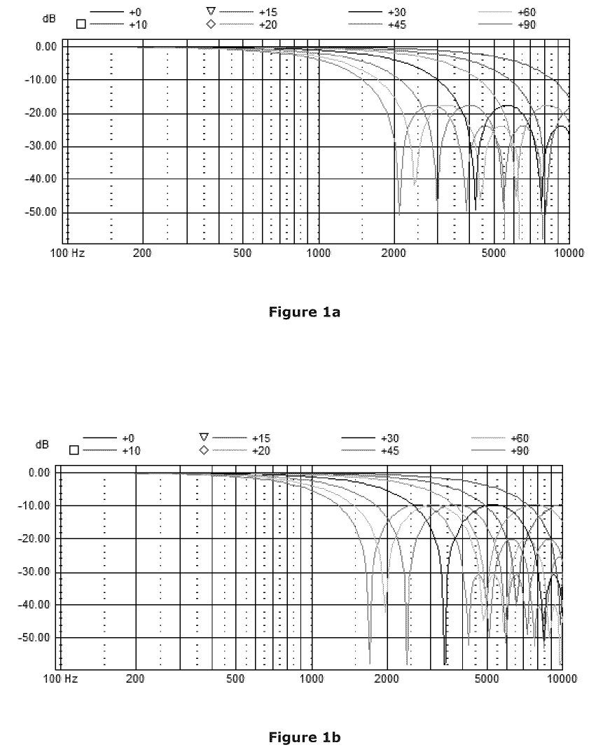

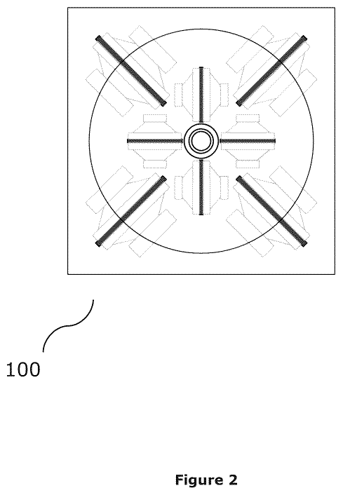

### DETAILED DESCRIPTION

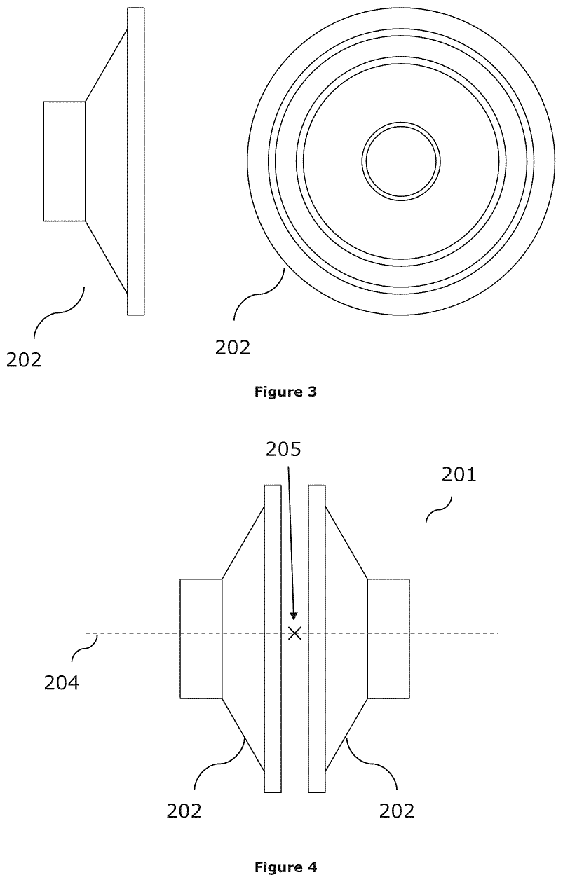

FIG. 2 illustrates a multiple-driver loudspeaker 100 according to the present invention. The multiple-driver loudspeaker 100 comprises driver assemblies that each comprise a pair of drivers. FIG. 3 illustrates an example of a driver 202 suitable for use with the present disclosure. The radiating surface of the driver 202 may be of any shape, in the illustrated example circular surfaces are used as examples. The radiating surface of the driver 202 may be flat or, as is more usual, have depth. The drivers 202 may use any type of motor systems. In some examples, moving coil motors may be used.

In some of the illustrated examples, the loudspeaker cabinets are shown to have sharp edges and corners. These are merely for illustrative purposes, and it should be understood that in some examples bevelling, chamfering or otherwise shaping of corners and/or edges may be used. In such examples, the bevelling, chamfering or otherwise shaping of corners and/or edges may advantageously reduce diffraction.

In some of the illustrated examples, sealed (or “non-ported”) enclosures are shown. However, other loading arrangements are envisaged such as reflex (also referred to as “ported”), passive radiator (also referred to as “drone cone” or “auxiliary bass radiator”), band pass, transmission line, or any other suitable loading techniques. Some of these example loading arrangements may be more preferable for certain frequency bands.

FIG. 4 illustrates a driver assembly 201 according to the present disclosure. The driver assembly 201 comprises a pair of matched drivers 202. In the example illustrated in FIG. 4, the drivers 202 are arranged face-to-face. The drivers 202 are arranged on a common central driver axis 204, which is bisected by a driver midpoint 205 lying between the drivers 202. The drivers 202 are physically connected, although this is not illustrated in the figure. In the example illustrated in FIG. 4, the drivers 202 are driven using an electrical signal that has the same polarity. In use, the drivers 202 thereby produce acoustic sound, but the inertial forces of the drivers 202 are cancelled out. The driver midpoint 205 is the midpoint between the voice coils of the two drivers 202 included in the driver assembly 201.

The inventors have determined that the gap between the pair of drivers 202 in the driver assembly 201 can be reduced further than may be expected, with little or no reduction in performance.

In some examples, the highest frequency that is produced by a given driver assembly 201, in use, is kept below a threshold value. In some examples, upper frequency problems may occur when the half-wavelength of the output frequency begins to approach the width, height or diagonal dimension of the manifold of the driver assembly 201. In some examples, the threshold value may be set so as to not exceed this limit. This can be beneficial because, with increasing frequency of acoustic sound output, when wavelengths approach half of any of any of the manifold dimensions cancellations can occur. In some examples, absorption may be used to mitigate cancellations at upper band frequencies.

In the illustrated examples, moving coil type loudspeaker drivers are shown. These are also referred to in the description, however it should be appreciated that any other type of loudspeaker drivers may be used instead of, or in addition to, moving coil type drivers. Some possible alternative driver types may be electrostatic, ribbon, air motion transformer and moving magnet drivers.

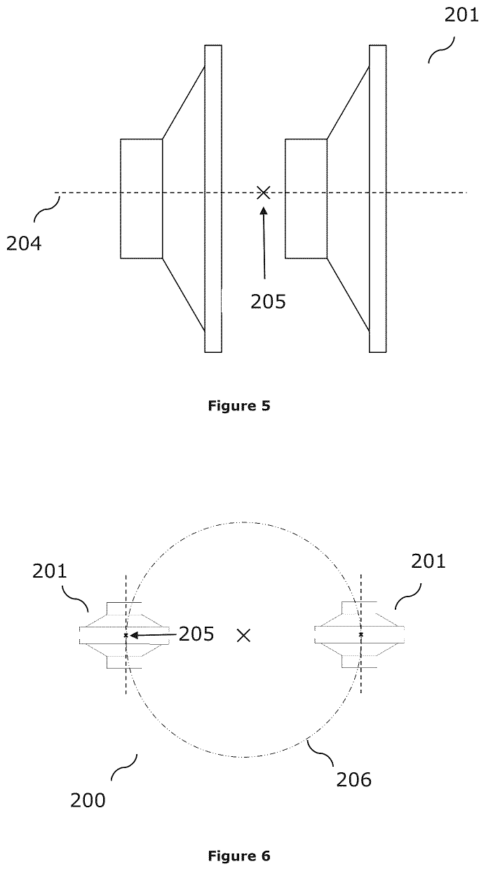

FIG. 5 illustrates an alternative driver assembly 201, with the drivers 202 arranged facing the same direction. The drivers 202 are arranged on a common central driver axis 204, which is bisected by a driver midpoint 205 lying between the drivers 202. The drivers 202 may be physically connected, although this is not illustrated in the figure. The driver midpoint 205 is the midpoint between the voice coils of the two drivers 202 included in the driver assembly 201.

Arranging the drivers 202 of a driver assembly 201 facing in the same direction, as illustrated in FIG. 5, may be advantageous in reducing the distortion produced by the driver assembly 201. This is because distortion produced by the driver coil of each of the drivers 202 will be different to that of the other driver 202 in the driver assembly 201, since in use they will be moving in opposite directions (due to being wired in opposite polarity).

The driver pairs may be located within a loudspeaker structure such that each has an enclosed air mass behind it that contains the radiation from the back of the moving diaphragm and prevents acoustic cancellation between the front and back radiation emitted by the speaker pair. Each pair may be physically coupled together by the cabinet structure, thereby cancelling common inertial forces. Each driver in a pair may be wired with its paired driver and other drivers in the same group using series and parallel combinations such that all drivers within a group present a resulting impedance which a common amplifier channel can drive efficiently. In some examples, all drivers within a group will have connection polarities observed such that all are adding to the overall output from the group. In some examples, each pair (or each individual driver) may be driven from separate amplifier channels.

In the example illustrated in FIG. 5, the drivers 202 are driven using the same electrical signal but with the drivers wired in opposite polarity. In use, the drivers 202 thereby sum to produce acoustic sound, but the inertial forces of the drivers 202 are cancelled out.

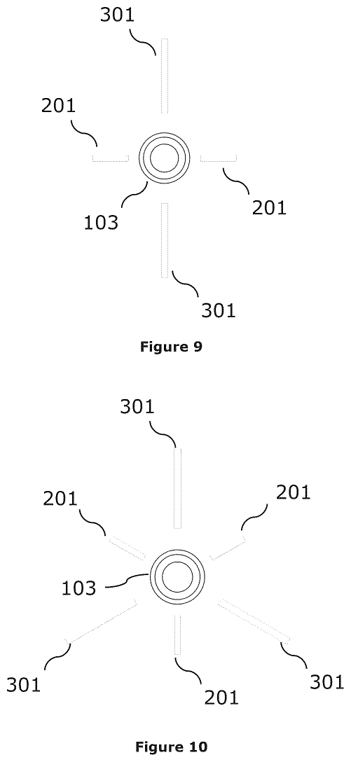

FIG. 6 illustrates a first group 200 of driver assemblies 201 arranged with the midpoint 205 of each driver assembly 201 arranged on a perimeter of a first circular plane 206. In the illustrated example, the first group 200 of driver assemblies 201 includes two driver assemblies 201. However, in some examples, more than two driver assemblies may be included in the first group. In some examples, as illustrated in FIG. 9 onwards, the first group may include three or four driver assemblies. Greater numbers of driver assemblies are also envisaged, as shown in FIG. 12, for example.

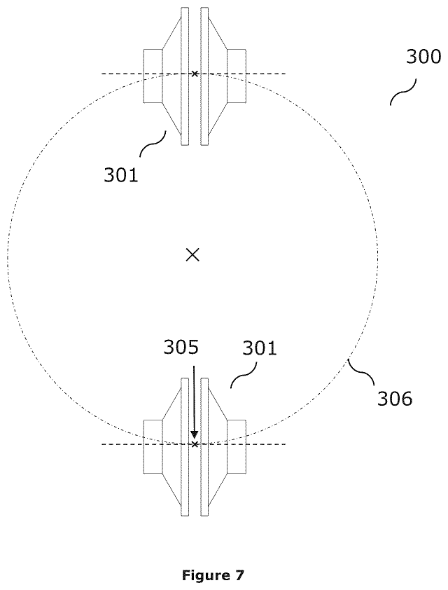

FIG. 7 illustrates a second group 300 of driver assemblies 301 arranged with the midpoint 305 of each driver assembly 301 arranged on a perimeter of a second circular plane 306. In the illustrated example, the second group 300 of driver assemblies 301 includes two driver assemblies 301. However, in some examples, more than two driver assemblies may be included in the second group. In some examples, as illustrated in FIG. 9 onwards, the second group may include three or four driver assemblies. Greater numbers of driver assemblies are also envisaged, as shown in FIG. 12, for example.

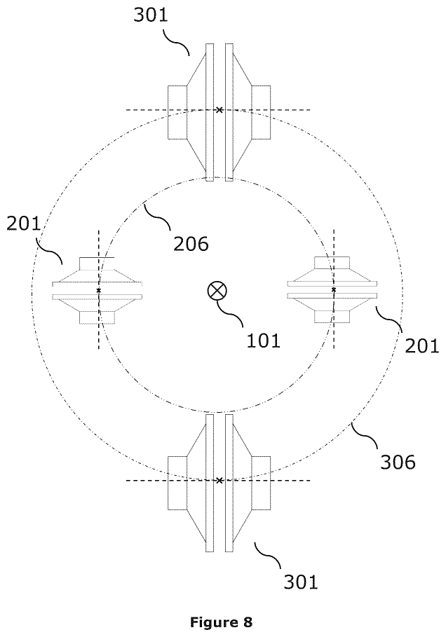

FIG. 8 illustrates the first group and second group of driver assemblies arranged such that the first circular plane 206 and the second circular plane 306 each extends around a common central planar axis 101. In the illustrated example, the first group of driver assemblies and the second group of driver assemblies are arranged such that the four illustrated driver assemblies 201, 301 are evenly spaced around the common central planar axis 101 with respect to each other. However, in some examples, the driver assemblies of different groups may be aligned with one another or may be arranged with non-equal separations.

In some examples, more than two groups of driver assemblies may be included in the multiple-driver loudspeaker. In such examples, further groups of driver assemblies may be arranged with the mid-point of each driver assembly on a perimeter of further circular planes, each arranged around the common central planar axis 101. In some examples, these additional circular planes may have different diameters. In some examples, these additional circular planes may have the same diameters as one or more other circular planes.

FIGS. 9 to 13 illustrate various examples of arrangements of driver assemblies according to the present disclosure. Other arrangements are also envisaged, the figures merely provide some illustrated examples of arrangement within the limitations of the present disclosure. For simplicity, in FIGS. 9 to 13 the driver assemblies are represented by slots. Each slot represents the gap between a pair of drivers in a driver assembly.

FIG. 9 illustrates a “two-fold” arrangement. Two first driver assemblies 201 and two second driver assemblies 301 are arranged around a common central planar axis (not shown). The driver assemblies are arranged such that they are evenly spaced around the common central planar axis, and such that the first driver assemblies 201 and second driver assemblies 301 alternate around the common central planar axis. Such an arrangement has two-fold rotational symmetry around the central planar axis. A central driver 103 is arranged with its driver central axis shared with the common central planar axis of the other driver assemblies, meaning that it is facing outwards from the planes of the other driver assemblies. The central driver 103 will typically be a single high-frequency driver, often referred to as a “tweeter”.

FIG. 10 illustrates a “three-fold” arrangement. Three first driver assemblies 201 and three second driver assemblies 301 are arranged around a common central planar axis (not shown). The driver assemblies are arranged such that they are evenly spaced around the common central planar axis, and such that the first driver assemblies 201 and second driver assemblies 301 alternate around the common central planar axis. Such an arrangement has three-fold rotational symmetry around the central planar axis. A central driver 103 is arranged with its driver central axis shared with the common central planar axis of the other driver assemblies, meaning that it is facing outwards from the planes of the other driver assemblies.

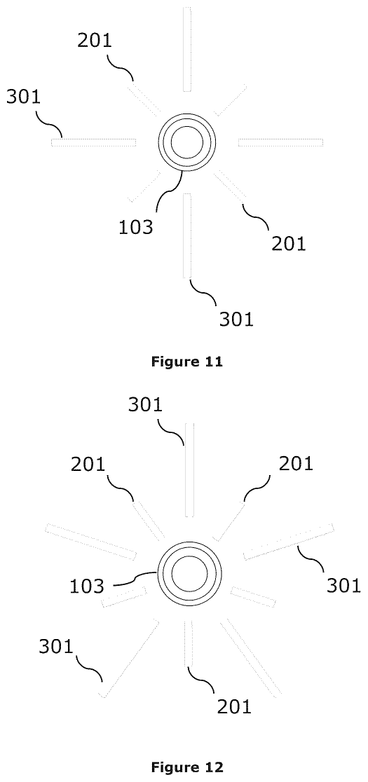

FIG. 11 illustrates a “four-fold” arrangement. Four first driver assemblies 201 and four second driver assemblies 301 are arranged around a common central planar axis (not shown). The driver assemblies are arranged such that they are evenly spaced around the common central planar axis, and such that the first driver assemblies 201 and second driver assemblies 301 alternate around the common central planar axis. Such an arrangement has four-fold rotational symmetry around the central planar axis. A central driver 103 is arranged with its driver central axis shared with the common central planar axis of the other driver assemblies, meaning that it is facing outwards from the planes of the other driver assemblies.

FIG. 12 illustrates a “five-fold” arrangement. Five first driver assemblies 201 and five second driver assemblies 301 are arranged around a common central planar axis (not shown). The driver assemblies are arranged such that they are evenly spaced around the common central planar axis, and such that the first driver assemblies 201 and second driver assemblies 301 alternate around the common central planar axis. Such an arrangement has five-fold rotational symmetry around the central planar axis. A central driver 103 is arranged with its driver central axis shared with the common central planar axis of the other driver assemblies, meaning that it is facing outwards from the planes of the other driver assemblies.

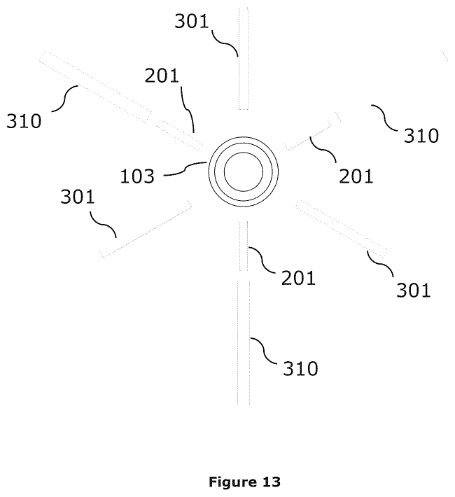

FIG. 13 illustrates a “three-fold, four-way” arrangement. Three first driver assemblies 201 and three second driver assemblies 301 are arranged around a common central planar axis (not shown). Three third driver assemblies 310 are arranged around the common central planar axis on a third circular plane with a central planar axis common with the central planar axes of the first and second circular planes (no circular planes are shown in the illustration). In the illustrated example, each of the third driver assemblies 310 is arranged adjacent to a first driver assembly 201. Such an arrangement may be beneficial, for example, in maximising spatial efficiency within the driver cabinet. The driver assemblies are arranged such that they are evenly spaced around the common central planar axis, and such that the first driver assemblies 201 and second driver assemblies 301 alternate around the common central planar axis. Such an arrangement has three-fold rotational symmetry around the central planar axis. A central driver 103 is arranged with its driver central axis shared with the common central planar axis of the other driver assemblies, meaning that it is facing outwards from the planes of the other driver assemblies. Each of the groups of driver assemblies in the illustrated example comprise a different size of drivers in their respective driver assemblies. In the illustrated example the central driver 103 is a different size to any used in the three respective driver groups, meaning that there are four different sizes of drivers used. The illustrated multiple-driver loudspeaker may therefore be referred to as a “four-way” loudspeaker.

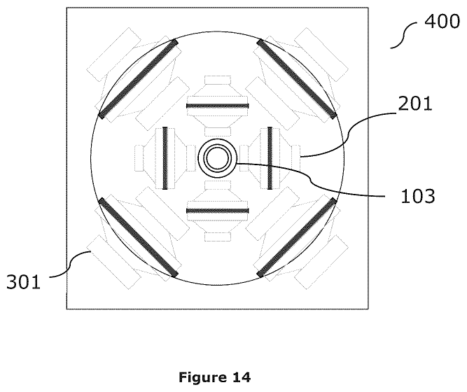

FIG. 14 illustrates a further example of a multiple-driver loudspeaker 400 according to the present disclosure including first driver assemblies 201, second driver assemblies 301, and a central driver 103. In this illustrated example, the driver assemblies 201, 301 are arranged in a different orientation than in the other illustrated examples. This (and the other examples) merely illustrates examples of how the various driver assemblies could be oriented, in practice any orientation may be used. In some examples, the driver assemblies of each respective group may be oriented in a non-symmetrical and/or non-uniform way. Different orientations may be advantageous for different applications, for example by allowing for different spatial requirements, easier construction or better cooling.

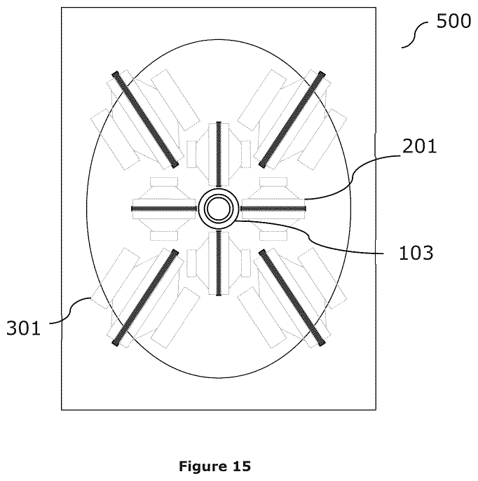

FIG. 15 illustrates a further example of a multiple-driver loudspeaker 500 according to the present disclosure. In this illustrated example, the multiple-driver loudspeaker 500 is not arranged in a symmetrical shape. Instead, one dimension of the front face is longer than the other, leading to a multiple-driver loudspeaker 500 that is taller than it is wide (for example). In this illustrated example, first driver assemblies 201 are arranged symmetrically, but the second driver assemblies 301 are arranged in a non-symmetrical manner in order to fill the multiple-driver loudspeaker 500 more efficiently. However, as illustrated in FIG. 16, the mid-points of each of the second driver assemblies 301 are still arranged on the perimeter of a circular plane 306, in accordance with the present disclosure.

Each of the examples discussed thus far may be used in any suitable loudspeaker cabinet, and in any arrangement or combination that falls within the present disclosure. As mentioned previously, two implementations of the present disclosure that are envisaged are “forward radiating loudspeakers” and “omnidirectional loudspeakers”.

Forward radiating loudspeakers are loudspeakers that radiate the majority of their sound in a forward direction. Forward radiating loudspeakers using conventional driver arrangements are widely available. However, as discussed in detail above, the present arrangement of driver assemblies results in significant advantages for forward radiating loudspeakers in accordance with the present invention.

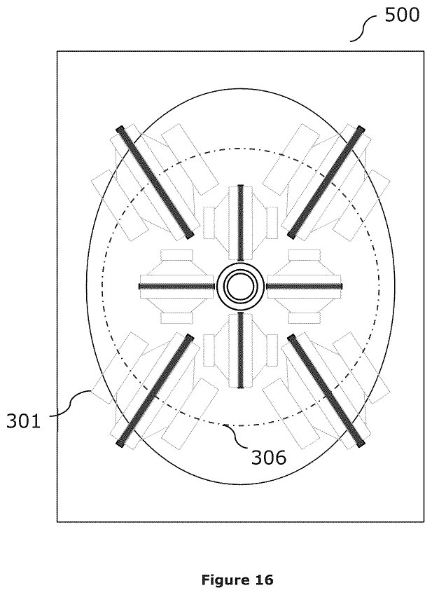

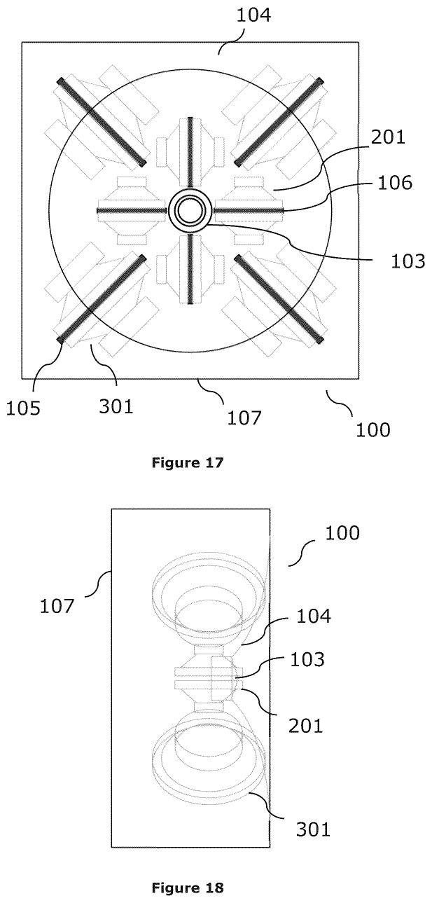

FIG. 17 illustrates an example of a multiple-driver loudspeaker 100 according to the present disclosure, arranged to produce forward radiating sound. In the illustrated example, a first group of driver assemblies includes four driver assemblies 201 arranged around a first circular plane (not shown). A second group of driver assemblies includes four driver assemblies 301 arranged around a second circular plane (not shown). In the illustrated example, an additional central driver 103 is included. The central driver 103 is arranged with its driver central axis shared with the common central planar axis the first and second circular planes. This means that the central driver 103 is arranged at the centre of the multi-driver loudspeaker 100, facing outwards from the circular planes on which the driver assemblies 201, 301 are arranged. The central driver 103 in the illustrated example is a high frequency driver, otherwise known as a “tweeter”.

In the illustrated example, the drivers of the first group of driver assemblies 201 are smaller than the drivers of the second group of driver assemblies 301. In some examples, the drivers of the first group of driver assemblies 201 may be equal to or larger than the drivers of the second group of driver assemblies 301. The diameter of the first circular plane on which the first group of driver assemblies 201 are arranged is smaller than that of the second circular plane on which the second group of driver assemblies 301 are arranged. In some examples, the circular plane of the second group may be equal to or smaller than that of the first group.

In the illustrated example, the driver assemblies 201, 301 of the first and second groups are arranged such that they are interleaved. This can be advantageous in improving the spatial efficiency of the driver arrangements, thereby reducing the overall size of the multiple-driver loudspeaker 400. In other examples, the driver assemblies of different groups may be aligned with one another.

The multiple-driver loudspeaker 400 illustrated in FIG. 17 has a housing 107 and a baffle 104. The housing surrounds the driver assemblies. Within the housing, each driver assembly may be contained within an enclosure (not shown). In some examples, enclosure spaces may be shared by driver assemblies configured to produce the same frequency band. The baffle 104 has first openings 105 each arranged next to a driver assembly 201 of the first group, and second openings 106 each arranged next to a driver assembly 301 of the second group. In use, the acoustic sound produced by the driver assemblies 201, 301 leaves the multiple-driver loudspeaker primarily though the adjacent openings 105, 106 in the baffle 104.

In some examples, enclosure spaces may be shared by groups of driver assemblies configured to produce the same frequency band. Usually, this will be the group(s) configured to produce the lowest of the frequency bands, with those groups of driver assemblies producing higher frequency bands each contained in individual driver assembly enclosures. In some examples, using individual enclosures for higher frequency driver assemblies may be advantageous in reducing and/or preventing standing waves from forming. In some examples, for a group of driver assemblies each contained in separate enclosures, each enclosure will have a substantially identical volume so that each driver in the group experiences the same load, in use.

In the illustrated example, the first openings 105 are smaller than the second openings 106. In some examples, the size of the openings is proportional to the size and frequency range of the driver assemblies that the opening is arranged next to, with larger lower frequency assemblies requiring larger openings. Each opening, being arranged next to a respective driver assembly, may be smaller than the surface area of the driver diaphragms of the driver assemblies that the respective openings are arranged next to. In some examples, the air mass being moved by the loudspeaker drivers may exit through openings. In some examples, the openings may be configured to prevent unwanted audible effects such as ‘chuffing’, for example by ensuring that the openings have sufficient area. In the illustrated examples, the openings are shown to be substantially rectangular, however other shapes may be used.

FIG. 18 illustrates a side view of the multiple-driver loudspeaker 100 illustrated in FIG. 17. The side view shows the back of the housing 107, and shows that the baffle 104 has a curved shape when viewed from the side. The illustrated baffle 104 has a shallow concave section extending inwards towards the mid-point of the baffle 104. Such a design can help match the directivity between frequency bands at upper crossover frequencies while also slightly widening the dispersion at the highest frequencies. This is particularly advantageous when compared to traditional loudspeaker designs that typically use flat baffles. Other examples are envisaged, where the shape of the baffle 104 may be adjusted in any suitable way to optimise the acoustic sound output of the multiple-driver loudspeaker 100.

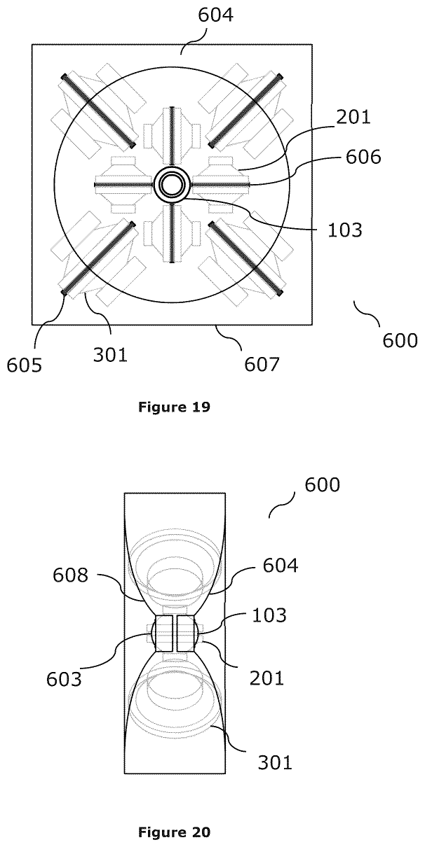

As noted above, a further advantage of the present disclosure is the possibility of providing a multiple-driver, full range loudspeaker with spherical (or near-spherical), coherent output throughout its frequency range. Such a loudspeaker may be referred to as an “omnidirectional” loudspeaker. An omnidirectional loudspeaker as described below has not previously been produced. Examples of possible implementations of the present disclosure to produce an omnidirectional loudspeaker are discussed below in reference to FIGS. 19 to 22.

FIG. 19 illustrates an example of a multiple-driver loudspeaker 600 according to the present disclosure, arranged to produce omnidirectional sound. In the illustrated example, a first group of driver assemblies includes four driver assemblies 201 arranged around a first circular plane (not shown). A second group of driver assemblies includes four driver assemblies 301 arranged around a second circular plane (not shown). In the illustrated example, an additional central driver 103 is included. The central driver 103 is arranged with its driver central axis shared with the common central planar axis the first and second circular planes. This means that the central driver 103 is arranged at the centre of the multi-driver loudspeaker 100, facing outwards from the circular planes on which the driver assemblies 201, 301 are arranged. The central driver 103 in the illustrated example is a high frequency driver.

The multiple-driver loudspeaker 600 has a housing 607 and a first baffle 604. The housing surrounds the driver assemblies. The first baffle 604 has first openings 605 each arranged next to a driver assembly 201 of the first group, and second openings 606 each arranged next to a driver assembly 301 of the second group.

FIG. 20 illustrates a side view of the multiple-driver loudspeaker 600 illustrated in FIG. 19. As noted above, the multiple-driver loudspeaker 600 illustrated in FIG. 20 is an omnidirectional loudspeaker, meaning that acoustic sound is radiated substantially equally from the front side and the back side of the multiple-driver loudspeaker 600. The acoustic sound emitted from each side originates from a perceived common central point, thereby producing the perception of an omnidirectional loudspeaker. The side view shows that the multiple-driver loudspeaker 600 comprises a first baffle 604 arranged on the front side of the multiple-driver loudspeaker 600, and a second baffle 608 arranged on the rear side of the multiple-driver loudspeaker 600. In the illustrated example, the first baffle 604 and the second baffle 608 are substantially identical. The illustrated baffles 604, 608 each have a shallow concave section extending inwards towards the mid-point of the baffles. Other examples are envisaged, where the shape of the baffles 604, 608 may be adjusted in any suitable way to optimise the acoustic sound output of the multiple-driver loudspeaker 600.

In the example illustrated in FIG. 20, a second high frequency driver 603 is included on the back side of the multiple-driver loudspeaker 600. This high frequency driver is arranged having a common driver axis with the front-facing high frequency driver 103, and are typically arranged back-to-back.

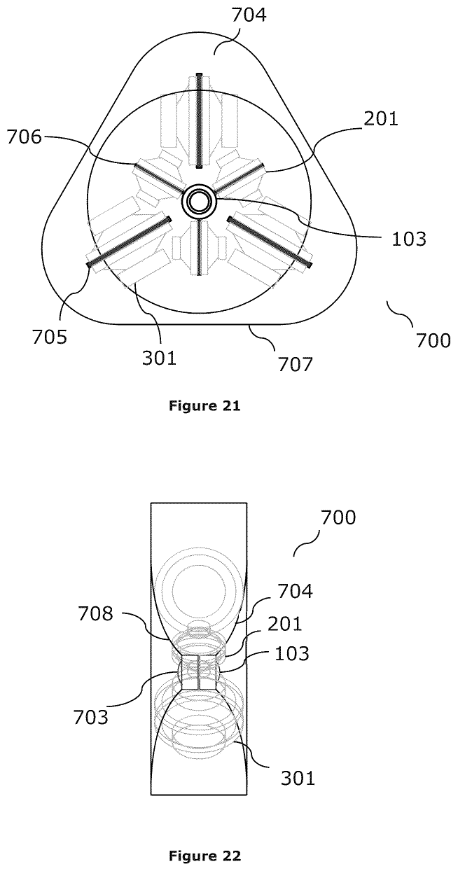

FIG. 21 illustrates a further example of a multiple-driver loudspeaker 700 according to the present disclosure. In the example illustrated in FIG. 21, the multiple-driver loudspeaker 700 includes three first driver assemblies 201 in the first group and three second driver assemblies 301 in the second group. As with the example illustrated in FIG. 19, the driver assemblies of the two groups are arranged such that they are interleaved. The multiple-driver loudspeaker 700 includes a housing 707, and a first baffle 704. The first baffle 704 has first openings 705 each arranged next to a driver assembly 201 of the first group, and second openings 706 each arranged next to a driver assembly 301 of the second group.

FIG. 22 illustrates a side view of the multiple-driver loudspeaker 700 illustrated in FIG. 21. The multiple-driver loudspeaker 700 illustrated in FIG. 21 is again an omnidirectional loudspeaker, meaning that acoustic sound is radiated equally from the front side and the back side of the multiple-driver loudspeaker 700, thereby producing spherical, coherent output throughout its frequency range.

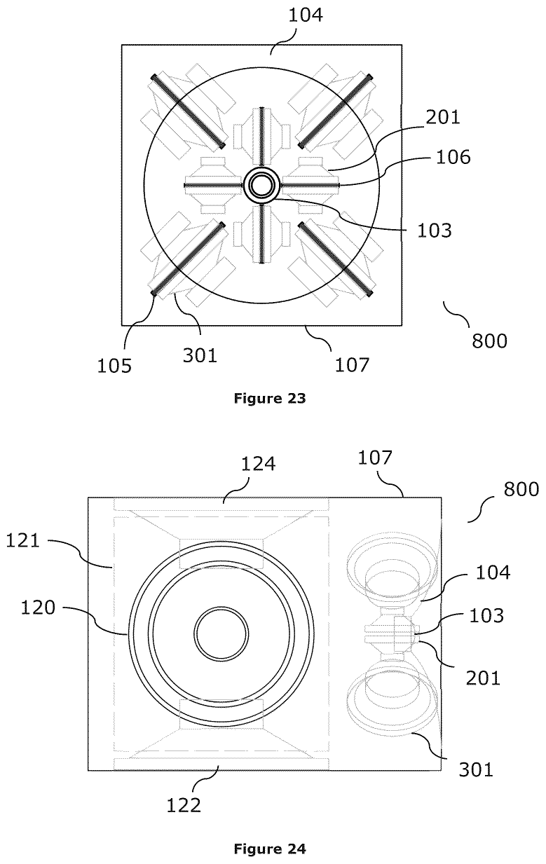

Aspects of the invention may be combined with additional low frequency (LF) drivers arranged separately to the driver assemblies 201, 301 described above, to extend the system LF capability. In some examples, these LF drivers may be included in the same loudspeaker housing as the other driver assemblies 201, 301. In some examples, the LF drivers may be contained within a separate housing or housings. Two examples of possible arrangements for such LF drivers are shown in FIGS. 23 to 26, although it should be appreciated that these are merely examples of how additional LF drivers could be included, and other arrangements are envisaged.

FIG. 23 illustrates a further example of a multiple-driver loudspeaker 800 according to the present disclosure, arranged to produce forward radiating sound and further including low frequency (LF) drivers (not shown in FIG. 23). In the example illustrated in FIG. 23, the multiple-driver loudspeaker 800 includes three first driver assemblies 201 in the first group and three second driver assemblies 301 in the second group. The multiple-driver loudspeaker 800 includes a housing 107, and a first baffle 104. The first baffle 104 has first openings 105 each arranged next to a driver assembly 201 of the first group, and second openings 106 each arranged next to a driver assembly 301 of the second group.

FIG. 24 illustrates a side view of the multiple-driver loudspeaker 800 illustrated in FIG. 23. Four LF drivers are included (although only 3 can be seen in the figure), with one arranged on each side of the loudspeaker housing 107. A first LF driver 120 is shown on the side of the housing 107 facing the viewer. A second LF driver 122 is shown on the bottom of the housing 107, and a third LF driver 124 is shown on the top of the housing 107. A fourth LF driver (not shown in the illustration) is arranged on the side of the housing that is not shown in the illustration.

In some examples, one LF driver may be included on each side of the housing (not including the front and the back of the housing), so that the number of LF drivers is determined by the number of sides that the housing includes. For example, a forward-facing multi-driver loudspeaker arranged similar to the illustrated example in FIG. 21 may include three LF drivers, since the housing has three sides (not including the front and back of the enclosure).

In some examples, each LF driver may be contained within an enclosure. In some examples, an enclosure may be shared between more than one LF driver. In the example illustrated in FIG. 24, the first LF driver 120 is contained within a first LF driver enclosure 121. The other LF drivers may also each be contained within an enclosure, or may share a single enclosure, however the other enclosures are not shown in the illustration.

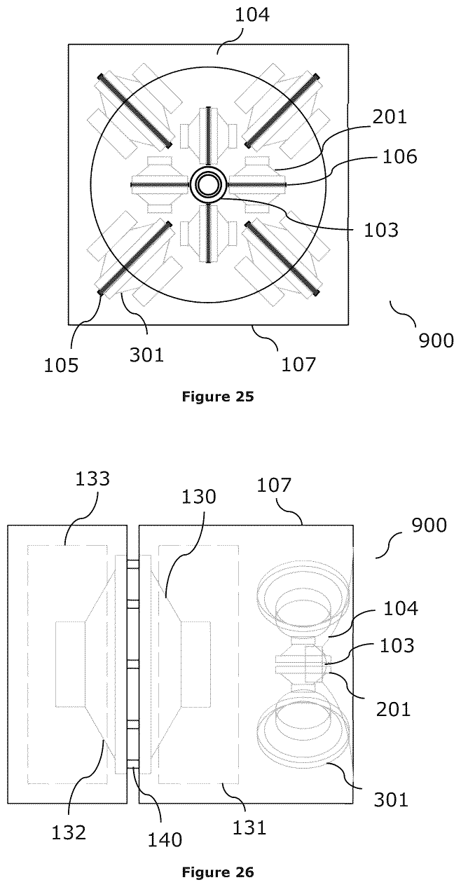

FIG. 25 illustrates a further example of a multiple-driver loudspeaker 900 according to the present disclosure, arranged to produce forward radiating sound and further including low frequency (LF) drivers (not shown in FIG. 25). In the example illustrated in FIG. 25, the multiple-driver loudspeaker 900 includes three first driver assemblies 201 in the first group and three second driver assemblies 301 in the second group. The multiple-driver loudspeaker 900 includes a housing 107, and a first baffle 104. The first baffle 104 has first openings 105 each arranged next to a driver assembly 201 of the first group, and second openings 106 each arranged next to a driver assembly 301 of the second group.

FIG. 26 illustrates a side view of the multiple-driver loudspeaker 900 illustrated in FIG. 25. Two LF drivers are included, arranged as a LF driver assembly and positioned such that they share a common central driver axis with the central planar axis of the other drivers. In some examples, each of the two LF drivers may be contained within an enclosure. In the illustrated example, the first LF driver 130 is contained within a first LF driver enclosure 131, and the second LF driver 132 is contained within a second LF driver enclosure 133. In the illustrated example, the first LF driver 130 is connected to the second LF driver 132 by LF driver connectors 140, or by cabinet connectors (not shown). As with the diver assemblies described above, the LF driver assembly in this example may be connected directly or indirectly. In some examples, the LF drivers 130, 132 may be arranged facing one another (as shown in FIG. 26) and driven using an electrical signal that has the same polarity. Alternatively, the LF drivers could be arranged facing the same direction and driven using an electrical signal that has the opposite polarity.

In each of the examples described in relation to FIGS. 23 to 26, the LF drivers are arranged in a manner that allows for the LF drivers to force cancel. Furthermore, LF drivers in the illustrated examples remain in a coaxial arrangement with all other drivers but with an offset to the rear of the loudspeaker. In practice, the offset is small at the probable LF crossover point compared to the wavelength of the acoustic sound being produced, so very little (if any) cancellation occurs in any direction.

Although the above description refers primarily to the use of driver assemblies in loudspeakers, it should be understood that other usages are envisaged. The above-described examples are to be considered merely possible uses of the present disclosure, and should not be considered limiting to the scope of the invention.

1-23. (canceled)

24. A multiple-driver loudspeaker, for converting electrical signals into acoustic sound, comprising a plurality of driver assemblies, each driver assembly including a pair of drivers arranged on a common central driver axis bisected by a driver midpoint lying between the drivers, the plurality of driver assemblies including:
a first group of driver assemblies in which the midpoint of each driver assembly lies on a perimeter of a first circular plane; and
a second group of driver assemblies in which the midpoint of each driver assembly lies on a perimeter of a second circular plane;
wherein the first and second circular planes each extends around a common central planer axis; and
wherein for each driver assembly, the pair of drivers are arranged facing each other and are driven using an electrical signal of the same polarity such that, in use, the pair of drivers of the driver assembly force-cancel.

25. The multiple-driver loudspeaker according to claim 24, wherein each driver assembly comprises a pair of matched drivers.

26. The multiple-driver loudspeaker according to claim 24, wherein the first and second circular planes are co-planar.

27. The multiple-driver loudspeaker according to claim 24, wherein the first and second circular planes have different diameters.

28. The multiple-driver loudspeaker according to claim 24, wherein the diameter of the first circular plane is smaller than the diameter of the second circular plane.

29. The multiple-driver loudspeaker according to claim 24, wherein for each respective circular plane, those driver assemblies lying on a perimeter of the circular plane are equally spaced from one another around the circular plane.

30. The multiple-driver loudspeaker according to claim 24, wherein the drivers of the first group of driver assemblies are smaller than the drivers of the second group of driver assemblies.

31. The multiple-driver loudspeaker according to claim 24, wherein, in use, the first group of driver assemblies are configured to produce frequencies in a first frequency band, and the second group of driver assemblies are configured to produce frequencies in a second frequency band that is at least partially non-overlapping with the first frequency band.

32. A multiple-driver loudspeaker, for converting electrical signals into acoustic sound, the multiple-driver loudspeaker comprising:
three or more driver assemblies, each driver assembly including a pair of drivers arranged on a common central driver axis bisected by a driver midpoint lying between the drivers, the midpoint of each of the three or more driver assemblies lying on a perimeter of a single circular plane,
wherein for each driver assembly, the pair of drivers are arranged facing each other and are driven using an electrical signal of the same polarity such that, in use, the pair of drivers of the driver assembly force-cancel.

33. The multiple-driver loudspeaker according to claim 32, wherein each driver assembly comprises a pair of matched drivers.

34. The multiple-driver loudspeaker according to claim 32 further comprising at least one driver arranged with a driver central axis shared with the common central planar axis of at least one circular plane.

35. The multiple-driver loudspeaker according to claim 32, wherein for each respective circular plane, those driver assemblies lying on a perimeter of the circular plane include drivers of equal size.

36. The multiple-driver loudspeaker according to claim 32, further comprising a first baffle disposed on a first side of the plurality of driver assemblies, the first baffle comprising one or more openings, each of the one or more openings being arranged adjacent to one of the driver assemblies.

37. The multiple-driver loudspeaker according to claim 36, wherein the first baffle further comprises one or more shaped portions.

38. The multiple-driver loudspeaker according to claim 36, further comprising a second baffle disposed on a second side of the plurality of driver assemblies, the second side being opposite to the first side such that the plurality of drivers are disposed between the first baffle and the second baffle, the second baffle comprising one or more openings, each of the one or more openings being arranged adjacent to one of the driver assemblies.

39. The multiple-driver loudspeaker according to claim 38, wherein the second baffle further comprises one or more shaped portions.

40. The multiple-driver loudspeaker according to claim 38, comprising a pair of matched drivers arranged with a driver central axis shared between the pair of drivers and with the common central planar axis of at least one circular plane, and arranged such that each driver of the pair of matched drivers faces outwards.

41. The multiple-driver loudspeaker according to any claim 32, further comprising one or more low-frequency driver assemblies, each low-frequency driver assembly including a pair of low-frequency drivers arranged on a common central driver axis, and wherein each of the respective low-frequency driver assemblies is arranged such that the common central driver axis of the low-frequency driver assembly is shared with the common central planar axis of at least one circular plane.

42. The multiple-driver loudspeaker according to claim 32, including at least one circular plane having a central planar axis, further comprising two or more low-frequency drivers, each low frequency driver having a driver central axis extending perpendicular to the central planar axis of the at least one circular plane, and arranged such that the low frequency drivers are equally spaced from one another.
